(19) United States
(12) Patent Application Publication
(10) Pub. No.: US 2014/0013803 A1
(43) Pub. Date: Jan. 16, 2014

(54) WINDOW FORMING DEVICE AND WINDOW FORMING METHOD USING THE SAME

(71) Applicant: SAMSUNG DISPLAY CO., LTD., Yongin-City (KR)

(72) Inventors: Seong-Jin Hwang, Yongin-City (KR); Kwan-Young Han, Yongin-City (KR); Dong-Ho Lee, Yongin-City (KR); Hyoung-Suk Roh, Yongin-City (KR); Mikiya Itakura, Yongin-City (KR)

(73) Assignee: SAMSUNG DISPLAY CO., LTD., Yongin-City (KR)

(21) Appl. No.: 13/753,169

(22) Filed: Jan. 29, 2013

(30) Foreign Application Priority Data
Jul. 12, 2012 (KR) 10-2012-0076174

(51) Int. Cl. C03B 23/03

(52) U.S. Cl. CPC C03B 23/0305
USPC 65/32.1; 65/291; 65/273

(57) ABSTRACT

A device for making a window includes a main body defining a first space and a second space, a first shaft provided in the first space and connected to the main body, a first die provided in the first space and connected to the first shaft, a second shaft connected to the main body, movable relative to the first shaft and extending to the first space from the second space, and a second die provided in the first space and connected to the second shaft.. The device further includes an air-tight chamber surrounding the first and second dies, a gas supply conduit and a gas discharge conduit connected to the chamber, and an actuator connected to the second shaft and configured to move the second shaft relative to the first shaft. At least one of the first and second dies has a flat area and a curved area.

### RELATED APPLICATIONS

This application claims priority to and the benefit of Korean Patent Application No. 10-2012-0076174 filed in the Korean Intellectual Property Office on Jul. 12, 2012, the entire contents of which are incorporated herein by reference.

### BACKGROUND

1. Field

The described technology relates generally to making a window for use in, for example, an electronic handheld device.

2. Discussion of the Related Technology

Recently, flat display devices, for example, liquid crystal display (LCD) devices or organic light emitting diode (OLED) displays are widely used in portable telephones, navigation devices, digital cameras, electronic books, portable game consoles, and various other terminals and mobile electronic devices.

Generally, in a display panel used in a mobile device, a transparent cover window is provided at a front side of the display panel for a user to view a display unit. The transparent cover window may be an outermost part of the device such that it may require excellent impact resistance against an external impact to protect the display panel inside the device.

Furthermore, the use of touch panels may also require significantly enhanced strength of the cover window as the transparent cover window is frequently touched by user's fingers or stylus pens, etc.

Also, in cases where such portable devices have a curved shape, the window including curved surfaces may be needed.

In one process of making a window with a curved surface, for example, a thick glass material is cut out and trimmed, and one surface thereof is machined by using a CNC machine to form a curved surface.

In such process, since the thick material is removed through the CNC machining, material is wasted and production cost is increased.

The above information disclosed in this Background section is only for enhancement of understanding of the background of the described technology and therefore it may contain information that does not form the prior art that is already known in this country to a person of ordinary skill in the art.

### SUMMARY

One aspect of the invention provides a window forming device for a display device for easily forming a curved window, and a window forming method using the forming device.

An embodiment provides a device for making a window including: a main body defining a first space and a second space; a first shaft provided in the first space and connected to the main body; a first die provided in the first space and connected to the fixed first shaft; a second shaft connected to the main body, movable relative to the first shaft and extending to the first space from the second space; a second die provided in the first space and connected to the second shaft; an air-tight chamber surrounding the first die and the second die; a gas supply conduit and a gas discharge connected to the chamber; and an actuator connected to the second shaft and configured to move the second shaft, wherein at least one of the first die and the second die has a flat area and a curved area.

The first die and the second die are disposed to be engaged with each other. The window formed by the device is about 0.5 mm to about 1.0 mm.

The window forming device further includes a lamp unit installed outside the chamber.

The lamp unit includes a plurality of infrared ray lamps, and at least a reflector and wherein the device further comprises at least a cooling pipe.

Another embodiment provides a method of making a window, the method including: providing the foregoing device; providing a glass material between the first and second dies of the device; maintaining the chamber of the device in a vacuous state; supplying nitrogen into the chamber; pressurizing the glass material for a first time period with the first and second dies at a glass softening temperature of the glass material in a first pressurizing stage;

pressurizing the glass material for a second time period with the first and second dies at a glass transition temperature of the glass material in a second pressurizing stage; and cooling the first die and the second die.

The glass transition temperature is about 540° C. to about 600° C., and the glass softening temperature is about 610° C. to about 680° C.

A pressure of about 0.5 kN or about 3 kN is applied in the first pressurization stage, and a pressure of about 0.45 kN to about 0.55 kN is applied in the second pressurization stage.

According to the embodiments, the curved window is formed using a die without machining a thick glass material, and thus, the production costs can be reduced.

### BRIEF DESCRIPTION OF THE DRAWINGS

FIG. 1 shows a cross-sectional view of a window forming device according to an embodiment.

FIG. 2 shows a magnified cross-sectional view of an upper die and a lower die of FIG. 1.

FIG. 3 shows a flowchart of a method for forming a window according to an embodiment.

FIG. 4 to FIG. 6 show a method for forming a window according to an embodiment.

FIG. 7 shows a graph indicating relationship between radius of curvature of a window and temperature.

FIG. 8 shows a graph indicating the relationship between the radius of curvature of a window and the pressure that is applied according to an embodiment.

### DETAILED DESCRIPTION

Hereinafter, embodiments are shown and described in detail such that they can be easily performed by those skilled in the art with reference to the accompanying drawings. As those skilled in the art would realize, the described embodiments may be modified in various different ways, all without departing from the spirit or scope of the present invention.

In order to describe the present invention more clearly, parts that are not related to the description may be omitted from the drawings, and the same symbols may be given to similar parts throughout the specification.

In the drawings, the thickness of layers, films, panels, regions, etc., may be exaggerated for clarity. In the drawings, for better understanding and ease of description, the thickness of some layers and areas may be exaggerated. It will be understood that when an element such as a layer, film, region, or substrate is referred to as being “on” another element, it can be directly on the other element or intervening elements may also be present.

In addition, unless explicitly described to the contrary, the word “comprise” and variations such as “comprises” or “comprising” will be understood to imply the inclusion of stated elements but not the exclusion of any other elements. It will be understood that when an element such as a layer, file, region, or substrate is referred to as being “on” another element, it can be on the other element or under the other element. The element may not be on another element in a gravity direction.

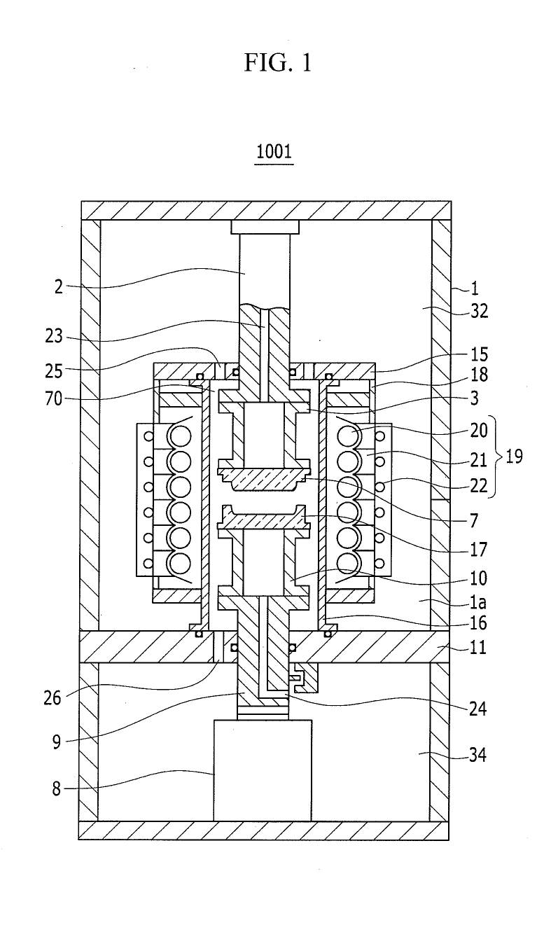

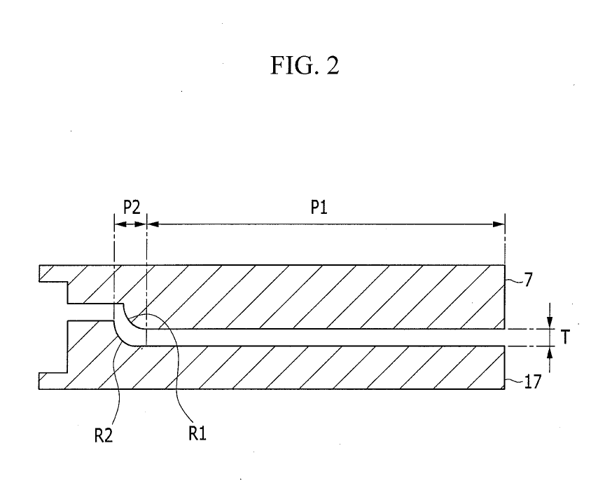

A window forming device 1001 according to an embodiment will now be described with reference to FIG. 1 and FIG. 2.

FIG. 1 shows a cross-sectional view of a window forming device according to an embodiment, and FIG. 2 shows a magnified cross-sectional view of an upper die and a lower die of FIG. 1.

As shown in FIG. 1, the window forming device 1001 includes: a main body 1 that defines a first space 32 and a second space 34; a fixed shaft 2 provided in the first space 32 of the main body 1; and a moving shaft 9 provided in the second space 34 of the main body 1 and extending to the first space 32 through a middle plate 11. The first space and the second space are used for the sake of convenience of explanation, and they can be called a top space and a bottom space when they are provided in the top to bottom direction as shown in the drawing.

A top heat insulating barrel 3 made of ceramic is provided on a bottom of the fixed shaft 2, and a upper die 7 is provided on a bottom of the top heat insulating barrel 3.

The moving shaft 9 is driven in the up or down direction, and it is connected to a driving device or actuator 8 provided in the second space 34. A bottom heat insulating barrel 10 like the top heat insulating barrel 3 is provided on a top of the moving shaft 9, and a lower die 17 is provided on a top of the bottom heat insulating barrel 10.

The upper die 7 and the lower die 17 are made of a metal material, and as shown in FIG. 2, and each of the dies includes a flat area P1 having a flat surface and a curved area P2 connected to the flat area P1 and having a curved surface.

In one embodiment, when forming a glass window of an electronic hand held device, a gap (T) between the upper die 7 and the lower die 17 can be adjusted to be about the thickness of the completed window of about 0.5 mm to about 1.0 mm. The radius of curvature R1 of a convex portion of the upper die that corresponds to an inner, concave side of the completed window can be about 5.0 mm, and a radius of curvature R2 of a concave portion of the lower die that corresponds to an outer, convex side of the window can be about 5.7 mm. Alternatively, the upper die can have a concave portion and the lower die has a convex portion so that the lower die can form the radius of curvature of the inner, concave side and the upper die can form the radius of curvature of the outer, convex side.

The heat insulating barrels 3 and 10, the upper die 7, and the lower die 17 are provided in an air-tight chamber 70. External air is blocked by a transparent quartz pipe or wall 16 from flowing into the chamber 70.

The chamber 70 is surrounded by an external barrel 18 secured to a bracket 15. The chamber 70 is connected to gas supply pipes or conduits 23, 24, and 25 and a discharge pipe or conduit 26. A lamp unit 19 is provided between an interior wall of the external barrel 18 and the chamber 70.

The gas supply conduits 23, 24, and 25 is connected to and in fluid communication with the inside of the chamber 70 to supply inert gas, for example, helium, nitrogen and so on, into the chamber 70, and the gas can be discharged through the discharge conduit 26 connected to and in fluid communication with the chamber 70.

In embodiments, the lamp unit 19 includes a plurality of infrared ray lamps 20, a plurality of reflectors 21 for reflecting infrared rays. A cooling pipe 22 for cooling the reflectors 21 is further provided. The lamp unit 19 applies heat to the upper die 7 and the lower die 17, and its temperature is controlled by a control device (not shown) connected to the lamp unit 19.

In order to form the window, with reference to FIG. 1, a glass material is provided between the upper die 7 and the lower die 17 and the glass material is pressurized by the upper die 7 and the lower die 17. The glass material can be a glass plate.

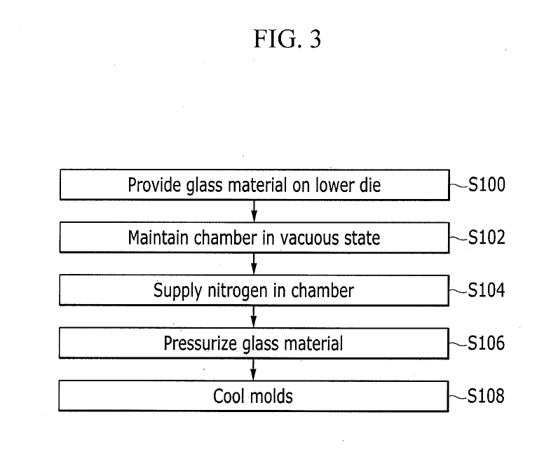

A method for forming a window according to an embodiment by using the window forming device will now be described with reference to FIG. 3 to FIG. 6.

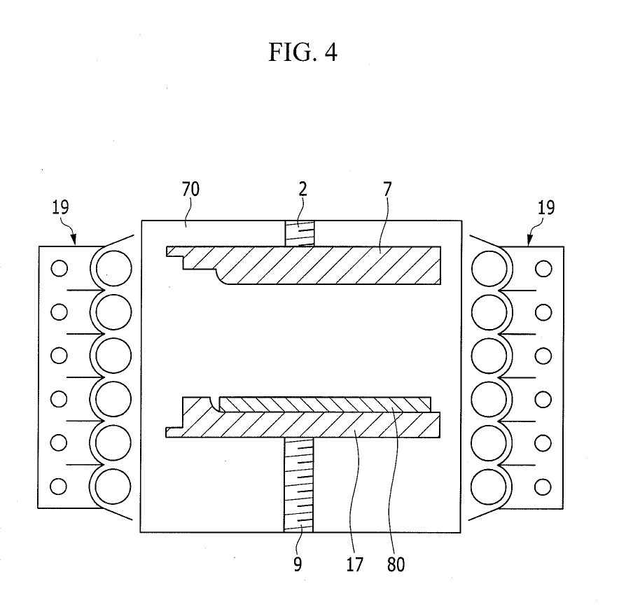

FIG. 3 shows a flowchart of a method for forming a window according to an embodiment, and FIG. 4 to FIG. 6 show a method for forming a window according to an embodiment.

As shown in FIG. 3, the window forming method includes: providing a glass material on a lower die (S100); maintaining the chamber in a vacuous state (S102); supplying nitrogen into the chamber (S104); pressurizing the glass material with the dies (S106); and cooling the dies (S108).

In detail, a method for forming a window by using a window forming device shown in FIG. 1 will now be described with reference to FIG. 3 and FIG. 4 to FIG. 6.

As shown in FIG. 3 and FIG. 4, a glass material is provided on a lower die 17 of a window forming device 1001 of FIG. 1 (S100). The glass material can be a flat glass plate, and for example, it can be soda lime glass made by Asahi or gorilla glass made by Corning.

As shown in FIG. 2, the lower die 17 includes a flat area P1 and a curved area P2, and it has a top surface shape which is substantially the same as the corresponding surface of the window to be formed.

To maintain the chamber 70 in the vacuous state (S102), air in the chamber 70 is purged or discharged to remove impurities from the chamber 70. Nitrogen gas is supplied for a first time to maintain the chamber 70 in a nitrogen atmosphere (S104). Nitrogen prevents the die from being oxidized.

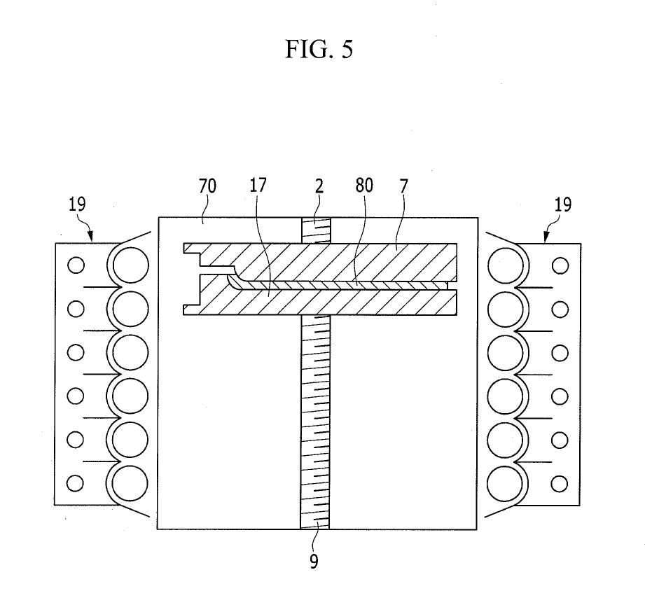

As shown in FIG. 3 and FIG. 5, the moving shaft 9 is lifted so that the lower die 17 may be engaged with the upper die 7 thereby pressurizing the glass material 30 (S106). In embodiments, in this instance, the supply of the nitrogen is maintained and an amount of nitrogen supplied in the chamber 70 is about ⅓ of the amount of nitrogen that is supplied before the pressurization.

In embodiments, pressurization can be performed in two stages, a first pressurization stage and a second pressurization stage so as to prevent thermal distortion. That is, pressurization of the first pressurization stage is performed for about one minute with a pressure of about 0.5 kN to about 3 kN at a temperature of about 610° C. to about 680° C. that is a glass softening temperature of the glass material.

In the pressurization in the second pressurization stage, the glass material is gradually cooled at the rate of about 2.6° C./second, and it is pressurized for about eight minutes with the pressure of about 0.45 kN to about 0.55 kN at a temperature of about 540° C. to about 600° C. that is a glass transition temperature.

When the glass material is pressurized in two stages as described, transformation of the dies caused by pressurization can be minimized and thermal stability is maintained to minimize the distortion phenomenon. That is, the window formed after the first pressurization stage is shrunk, and the shape of the window is stabilized by maintaining the temperature and the pressure in the second pressurization stage.

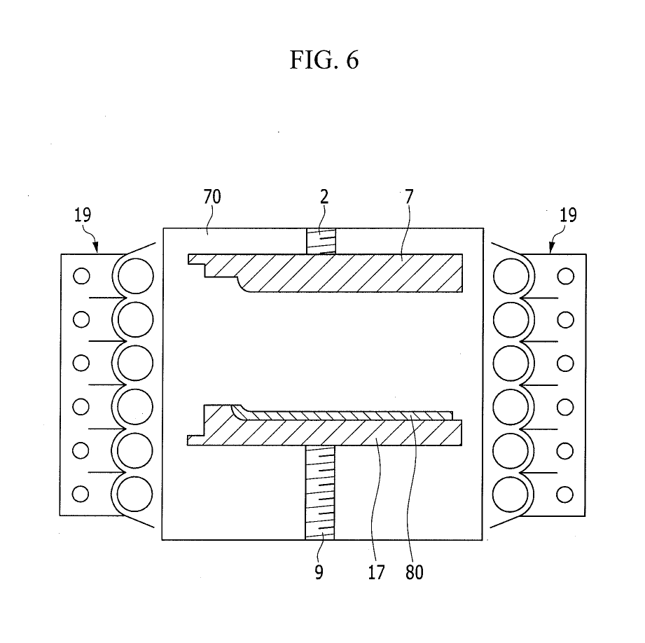

As shown in FIG. 3 and FIG. 6, nitrogen is supplied in the chamber 70 to cool the upper die 7 and the lower die 17 (S108). In embodiments, the amount of nitrogen supplied to the chamber 70 may be substantially the same as the amount of nitrogen supplied before forming a window. In embodiments, the formed window can be cooled while being disposed between the first and second dies and while the dies are being cooled.

The dies are cooled to about 220° C. at a cooling rate higher than the cooling rate for reaching the temperature of the second pressurization stage.

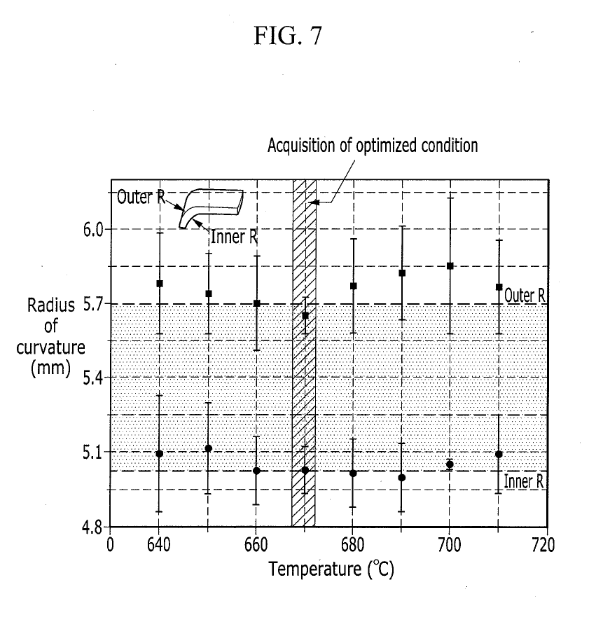

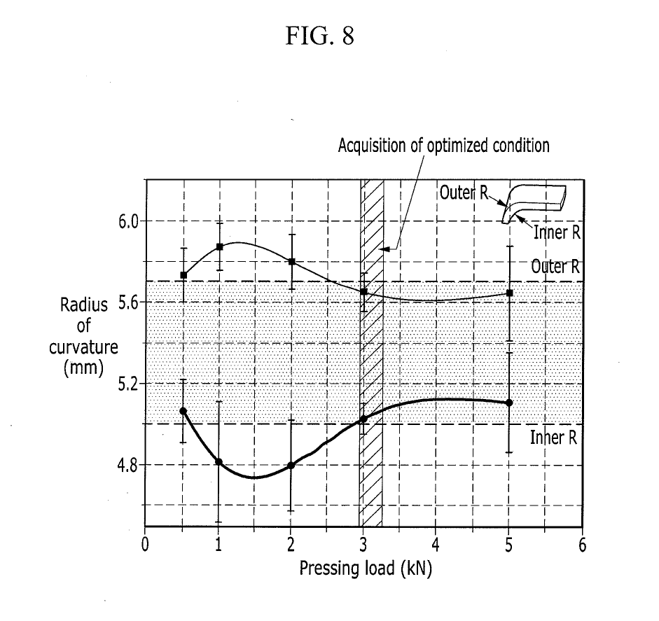

FIG. 7 shows a graph indicating the relationship between the radius of curvature of a window product and the die temperature, and FIG. 8 shows a graph indicating the relationship between the radius of curvature of a window product and the pressure that is applied for the first pressurization stage according to an embodiment.

In embodiments, the inner radius of curvature of the window to be formed is set to be about 5.0 mm, the outer radius of curvature is set to be about 5.7 mm, and the thickness of the window is set to be about 0.7 mm.

As shown in FIG. 7, when the temperature of the dies is set to be about 660° C. to about 680° C., a window having an inner radius of curvature of about 5.0 mm can be formed. The window having an outer radius of curvature of about 5.7 mm and a thickness of about 0.7 mm can be formed.

As shown in FIG. 8, when the pressure in the first pressurization stage is set to be about 0.5 kN or when the pressure in the first pressurization stage is set to be about 3 kN to about 5 kN, the inner radius of curvature of the window and the outer radius of curvature thereof can be similar to the required dimensions.

While this disclosure has been described in connection with what is presently considered to be embodiments, it is to be understood that the invention is not limited to the disclosed embodiments, but, on the contrary, is intended to cover various modifications and equivalent arrangements included within the spirit and scope of the appended claims.

What is claimed is:

1. A device for making a window comprising:
a main body defining a first space and a second space;
a first shaft provided in the first space and connected to the main body;
a first die provided in the first space and connected to the first shaft;
a second shaft connected to the main body, movable relative to the first shaft and extending to the first space from the second space;
a second die provided in the first space and connected to the second shaft;
an air-tight chamber surrounding the first die and the second die;
a gas supply conduit and a gas discharge conduit connected to the chamber; and
an actuator connected to the second shaft and configured to move the second shaft relative to the first shaft,
wherein at least one of the first die and the second die has a flat area and a curved area.

2. The device of claim 1, wherein the first die and the second die are disposed to be engaged with each other.

3. The device of claim 2, wherein the window formed by the device has a thickness of about 0.5 mm to about 1.0 mm.

4. The device of claim 1, further comprising a lamp unit installed outside the chamber.

5. The device of claim 4, wherein the lamp unit comprises a plurality of infrared ray lamps and at least a reflector, and wherein the device further comprises at least a cooling pipe.

6. A method of making a window, the method comprising:
providing the device of claim 1;
providing a glass material between the first and second dies of the device;
maintaining the chamber of the device in a vacuous state;
supplying nitrogen into the chamber;
pressurizing the glass material for a first time period with the first and second dies at a glass softening temperature of the glass material in a first pressurizing stage;
pressurizing the glass material for a second time period with the first and second dies at a glass transition temperature of the glass material in a second pressurizing stage; and
cooling the first and second dies.

7. The method of claim 6, wherein
the glass transition temperature is about 540° C. to about 600° C., and
the glass softening temperature is about 610° C. to about 680° C.

8. The method of claim 7, wherein
a pressure of about 0.5 kN or about 3 kN is applied in the first pressurization stage, and
a pressure of about 0.45 kN to about 0.55 kN is applied in the second pressurization stage.
